(19) United States
(12) Patent Application Publication
(10) Pub. No.: US 2007/0251990 A1
(43) Pub. Date: Nov. 1, 2007

(54) Self service prepay dry cleaning locker system

(76) Inventor: Anita LeNorman, Cypress, TX (US)

Correspondence Address: Anita LeNorman, 19614 Narcissus Brook Lane, Cypress, TX, 77433, US

(21) Appl. No.: 11/784,144

(22) Filed: Apr. 6, 2007

Related U.S. Application Data
(60) Provisional application No. 60/795,662, filed on Apr. 28, 2006.

(51) Int. Cl. G06F 17/00

(52) U.S. Cl. 235/375; 235/380

(57) ABSTRACT

The self service prepay dry cleaning locker system is composed of a unit which houses the software, keyboard, printer, disposable bags and a determinate number of lockers for the available space. The system allows for customers to access a drop off and delivery location for their articles to be dry cleaned. This would be accessible 24 hours a day, 7 days a week. This would also allow for a dry cleaning establishment to keep their overhead low, while being able to expand their customer base by being accessible outside of normal operating hours.

### RELATED APPLICATIONS

The present application is a continuation-in-part application of U.S. provisional patent application Ser. No. 60/795,662, filed Apr. 28, 2006, for PREPAY DRY CLEANING SYSTEM FOR RESIDENTIAL COMPLEX, by Anita LeNorman, included by reference herein and for which benefit of the priority date is hereby claimed.

### FIELD OF THE INVENTION

The present invention relates to prepay dry cleaning systems and more particularly to the prepaying, storing and delivering for articles to be dry cleaned.

### BACKGROUND OF THE INVENTION

Dry cleaning is a convenience that carries with it time constraints for the consumer. Employees working standard working hours often lack the time to compete this chore. Since most dry cleaning facilities are open during standard working hours, employers often hire people for pickup and deliver of dry cleaning, but along with these services come liability, safety issues and again, scheduling problems since people have to be present in order to complete the transaction. The consumer is left again with scheduling problems if delivery is delayed, or the consumer can not meet with the delivery people due to unforeseen circumstances. With some of the present day ideas of being able to place clothing in bags for drop off, disputes between the customer and dry cleaning establishment can erupt due to the customer not being able to convey to the dry cleaning establishment specific instructions in regards to the cleaning of the articles. Location of dry cleaning establishments can also create problems.

Most dry cleaning establishments still handwrite tickets. This creates the liability of human error in the instructions of processing the clothing or the tallying of the billing. Also, many customers are unaware of when their articles have been processed and are ready for pickup, possibly creating problems with decisions of what articles will be available for business trips.

If dry cleaning establishments were to remain open at all times that were easily accessible to customers, their overhead would increase drastically. Overhead would include things like salaries for extra people and increased utility bills. Also, with employees working shift work, there is the increase of safety issues for the employee, therefore increasing the liability for the establishment. With this type of exposure, obtaining insurance coverage for the establishment could be a problem since most companies do not want to write coverage for establishments open 24 hours a day. There is the increased exposure for crime, increasing the possibility for payment of claims. If the establishment would have to locate a surplus lines market insurance company that would place the coverage for them, causing them pay an additional premium, fees and taxes, which would add up to more than what they would have initially paid through a standard admitted market insurance company.

Dry cleaning establishments have made an attempt to open earlier or stay open later, but this has still not been suitable to gaining the customer base due to time constraints. Other drop off and pickup equipment for dry cleaning has been developed, for example in U.S. Pat. No. 6,010,239 and 5,509,572. With U.S. Pat. No. 6,010,239, this only allows for drop off and leaves the customer with the inconvenience of again, having to meet the time constraints for picking up the dry cleaning at the dry cleaning establishment. U.S. Pat. No. 6,010,239, while it allows for the drop off and pick up of dry cleaning, the invention would be more expensive to install and maintain.

### SUMMARY OF THE INVENTION

In accordance with the present invention, there is provided prepaid locker system that is composed of a single unit which houses the software, keyboard, printer and bags and a determinate number of lockers for the available space. The customer would swipe their credit or debit card and enter their personal information such as name and address. The customer would then use the touch screen to enter the data on the articles of clothing being dropped off for dry cleaning. This would be such things as types of articles, material type, number of articles and basic information (ie: with or without starch, pressing style). There is a keyboard which will allow the customer to enter any additional data for special instructions regarding the cleaning or alterations of any articles. The software will then tally the cost of cleaning and alterations and deduct the amount from the credit or debit card. The money will then be deposited into the appropriate accounts for the dry cleaning establishment. The software will then assign a locker number for the drop off, produce a ticket for the customer, a label to be placed on the bag with all pertinent information, a disposable bag to place the articles into and trigger the locking system for the particular locker assigned. The customer would place the articles into the disposable bag, seal the bag and attach the label to the outside of the bag, then open and place the bag in the bottom of the assigned locker and close it. The software will then trigger the bottom of the locker to lock again. The software would then notify the cleaning establishment that there are articles to be picked up along with the customer information and data entered for the articles to be cleaned. Upon picking up the articles, the cleaning establishment would then swipe their master card, which tells the software to trigger the locking system to unlock all the lockers. The cleaning establishment would then pickup the articles to be cleaned. Upon returning the articles to the location, the cleaning establishment would then swipe their master card, telling the software again to trigger the locking system to unlock all the lockers. The cleaning establishment would then place or hang the returned articles in the top section of the lockers to which they are assigned. They would then close the lockers, swipe their master card, telling the software to relock the lockers. The system would then send an e-mail to the customer advising them that their articles are ready for pickup. The customer, coming in to pickup their articles, would swipe their debit or credit card so that any additional charges could be collected and then they software would trigger the locking system on the assigned locker allowing the customer to access their articles. When the customer opens the locker, removes their articles and closes the locker, the software will then trigger the locking system to relock the locker. A notification will then be sent to the dry cleaning establishment that the articles have been picked up by the customer.

Even though all lockers are attached, they are still separated so that customers are only allowed access to their articles. The number and size of the lockers can be adjusted to accommodate different size spaces. The software can be manipulated to accept credit cards, debit cards or member cards, depending on the location of the prepaid locker system.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front perspective view of a FIG. 1 is a perspective frontal view of the self service perpay dry cleaning locker system;

FIG. 2 is a flow chart view of a FIG. 2 is a flow chart of the transactions and process by the software to manipulate the system;

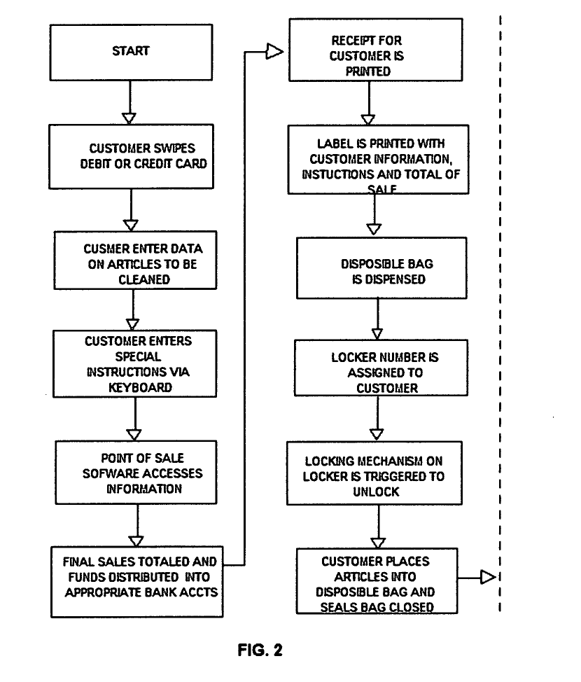

FIG. 3 is a flow chart view of a FIG. 3 is a continuation of FIG. 2 flow chart of transactions and process by the software manipulating the system;

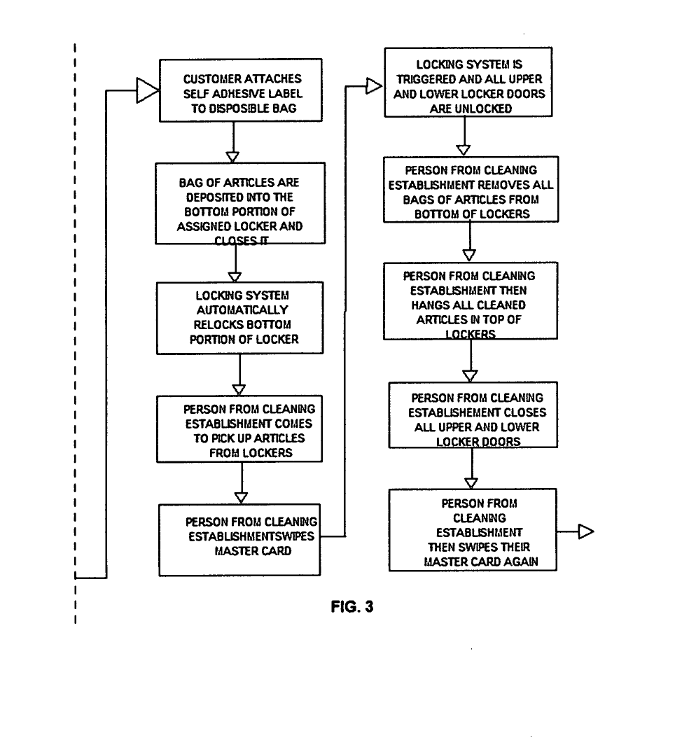

FIG. 4 is a flow chart view of a FIG. 4 is a continuation from FIG. 3 flow chart of transactions and process by the software manipulating the system; and

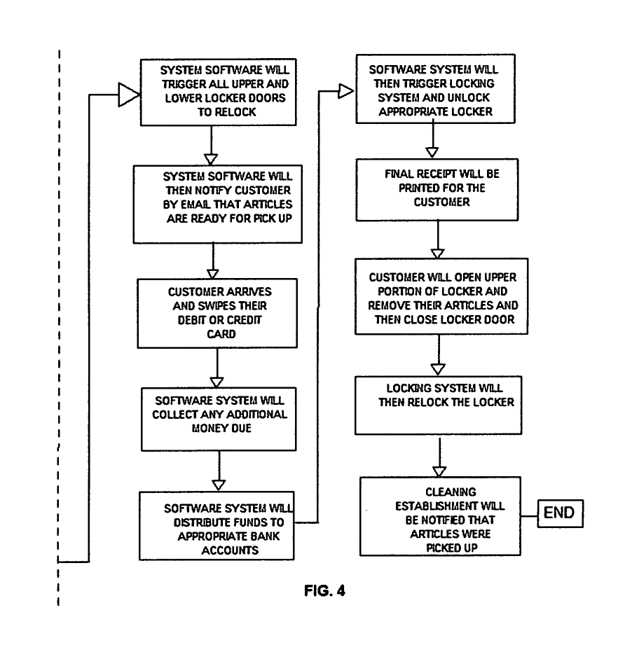

FIG. 5 is a perspective view of a FIG. 5 is a perspective view of the front of the self service prepay dry cleaning locker system displaying the upper locker compartment open, the lower locker compartment open and the housing unit open in the front displaying the disposable bag dispenser unit and additional storage.

For purposes of clarity and brevity, like elements and components will bear the same designations and numbering throughout the Figures.

### DESCRIPTION OF THE PREFERRED EMBODIMENT

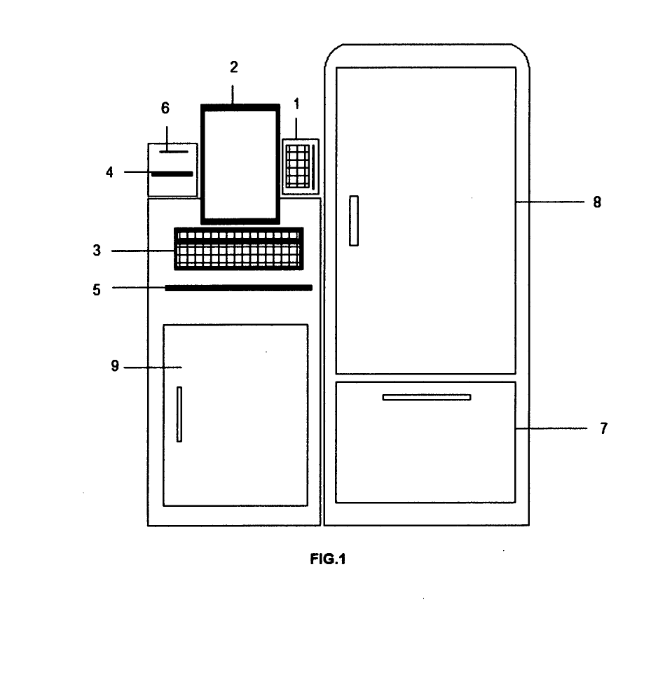

FIG. 1 is a perspective frontal view of the self service pre pay dry cleaning system. The unit, which can be constructed of metal, or some other suitable material, houses the software, computer touch screen 2, master/credit/debit card reader 1, keyboard 3, label printer 4, disposable bag dispenser slot 5, receipt printer 6 and disposable bag dispensing unit 9. The specially designed locker, which can also be constructed of metal, or some other suitable material, has two compartments, the upper locker compartment 8 for hanging or storing returned articles, and the lower locker compartment 7 to deposit bagged articles for pickup by the dry cleaning establishment.

Referring to FIG. 1, the computer touch screen 2, master/credit/debit card reader 1, keyboard 3, receipt printer 6 and label printer 4 can be purchased from various vendors. It is combining these items and using software specifically written for this apparatus that makes this the main control system for the self service prepay dry cleaning locker system. The computer touch screen 2 is mounted on the upper portion of the box unit, with the master/credit/debit card reader 1 on the right side and the receipt printer 6 and the label printer 4 on the left side. The keyboard 3 is attached to the housing unit, below and in front of the computer touch screen 2.

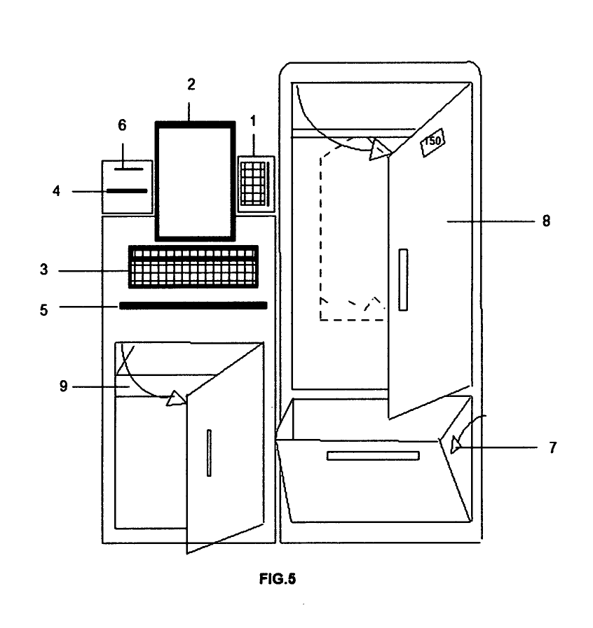

Referring to FIG. 5, upper locker compartment 8 opens to display a bar for hanging the cleaned articles, with enough space on the bottom for stacking any folded items. Also referring to FIG. 5, the lower locker compartment 7 opens for the customer do deposit the bagged articles for dry cleaning. Referring to FIG. 5 again, the bottom portion of the unit opens to display the disposable bag dispenser unit. The disposable bag dispenser unit contains a roll of disposable bags on a bar. When the software triggers the system to dispense a disposable bag, the bar is rotated by the gear system, turning the roll of disposable bags and the bag is dispensed through the disposable bag dispenser slot 5. The additional space below the bar for disposable bags can be used for storing additional rolls of disposable bags.

The unit is plugged in by using a standard electrical outlet, utilizing 110V, DC voltage. The software, specifically written to manipulate the system, is downloaded into the computer, housed in the unit, thru a DSL cable line. The software can then be controlled and repaired through a central station manned by the software vendor. This reduces the cost of purchasing software for each unit, and it also reduces the cost for any repair. The software technicians can download, manipulate and repair the software without having to personally go to the unit.

The master/credit/debit card reader 1 acts much like the merchant account card readers. The customer will swipe their credit or debit card. The master/credit/debit card reader 1 activates the computer software. The computer software, which is specifically written, and displays in the appropriate language chosen by the customer, to manipulate the system, will then present a screen that welcomes the customer and will guide them through the process of entering their personal information and data on each article that they will be depositing in the lower locker compartment 7 by use of the computer touch screen 2 and keyboard 3. Once the information on the customer and the articles to be bagged and deposited into the lower locker compartment 7, the software will total the amount due. The software will then deduct the monies owed from the customer's bank account or credit card account and then deposit the funds into the appropriate bank accounts, hence prepaid. The software will then assign an unoccupied locker and trigger the locking system to unlock the lower locker compartment 7. A receipt for the customer is printed by the receipt printer 6, which contains the customer's personal information, data on the articles that will be bagged to be deposited into the lower locker compartment 7, total for the final transaction and the assigned locker number. The software will trigger the disposable bag dispenser slot 5 to dispense a disposable bag and print a self adhesive label, containing the customer's personal information, data and special instructions on the articles to be bagged and deposited into the lower locker compartment 7, total of the transaction and the assigned locker number. The customer will place the articles into the disposable bag, pull the protective strip from the adhesive and then close and seal the disposable bag. The customer will then open the lower locker compartment 7 by pulling forward and the compartment door open, much like a mail chute and deposit the bagged articles into the lower locker compartment 7. The customer will then close the lower locker compartment 7. The software will then trigger the locking system to relock the lower locker compartment 7. The software will then notify the dry cleaning establishment that there are bagged articles to be picked up for dry cleaning.

The dry cleaning establishment will swipe their master card in the master/credit/debit card reader 1. The software will then trigger the locking system to unlock every one of the lower locker compartment 7 and upper locker compartment 8. The person from the dry cleaning establishment will then pick up all the bagged articles from every one of the lower locker compartment 7 and then hang or place the customer's cleaned, returned articles in the appropriately upper locker compartment 8 of their assigned locker. The person from the dry cleaning establishment will then swipe their master card again in the master/credit/debit card reader 1. The software will then trigger the locking system to relock all the locker compartments. The software will then notify the customer that their articles are ready for pickup.

The customer will swipe their credit or debit card into he master/credit/debit card reader 1. The software will access the customer's information, collect any additional funds due and print the final receipt for the customer and dispense it from the receipt printer 6. The software will then trigger the locking system to unlock the upper locker compartment 8 of the appropriately assigned locker. The customer would open the compartment by pulling the handle out and the door will open as any other door. The customer would then remove the articles and close the upper locker compartment 8. The software will then trigger the locking system to relock the upper locker compartment 8. The software will then notify the dry cleaning establishment that the articles were picked up.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A self service prepay dry cleaning locker system for a self service prepay dry cleaning locker system for prepaying, storing and delivering articles to be dry cleaned, comprising:
means for swiping cleaning establishment master card for controlling the locking system or the lockers. it also reads the customers debit or credit card for sale transactions;
means for displays the data entered by touching the screen or keyboard entry, adjacently mounted to said means for swiping cleaning establishment master card for controlling the locking system or the lockers. it also reads the customers debit or credit card for sale transactions;
means for allows customers to enter any additional instructions or information that they are unable to enter by touch screen, approximately positioned to said means for displays the data entered by touching the screen or keyboard entry;
means for prints the label that will be applied to the disposable bag, adjacently connected to said means for displays the data entered by touching the screen or keyboard entry;
means for dispenses disposable bags;
means for prints a receipt of the sales transaction, approximately interconnected to said means for prints the label that will be applied to the disposable bag, and adjacently constructed to said means for displays the data entered by touching the screen or keyboard entry;
means for opens by pulling forward and is used for placing the bagged articles in the locker for pick up by the dry cleaning establishment, peripherally connected to said means for displays the data entered by touching the screen or keyboard entry;
means for opens for hanging or placing in the cleaned articles for storage for the customer to retrieve, peripherally connected to said means for displays the data entered by touching the screen or keyboard entry; and
means for disposable bags are on rolling system that dispenses the bags thru the disposable bag dispenser, assembly connected to said means for dispenses disposable bags, and peripherally connected to said means for displays the data entered by touching the screen or keyboard entry.

2. The self service prepay dry cleaning locker system in accordance with claim 1, wherein said means for swiping cleaning establishment master card for controlling the locking system or the lockers. it also reads the customers debit or credit card for sale transactions comprises a master/credit/debit card reader.

3. The self service prepay dry cleaning locker system in accordance with claim 1, wherein said means for displays the data entered by touching the screen or keyboard entry comprises a computer touch screen.

4. The self service prepay dry cleaning locker system in accordance with claim 1, wherein said means for allows customers to enter any additional instructions or information that they are unable to enter by touch screen comprises a keyboard.

5. The self service prepay dry cleaning locker system in accordance with claim 1, wherein said means for prints the label that will be applied to the disposable bag comprises a label printer.

6. The self service prepay dry cleaning locker system in accordance with claim 1, wherein said means for dispenses disposable bags comprises a disposable bag dispenser slot.

7. The self service prepay dry cleaning locker system in accordance with claim 1, wherein said means for prints a receipt of the sales transaction comprises a receipt printer.

8. The self service prepay dry cleaning locker system in accordance with claim 1, wherein said means for opens by pulling forward and is used for placing the bagged articles in the locker for pick up by the dry cleaning establishment comprises a lower locker compartment.

9. The self service prepay dry cleaning locker system in accordance with claim 1, wherein said means for opens for hanging or placing in the cleaned articles for storage for the customer to retrieve comprises an upper locker compartment.

10. The self service prepay dry cleaning locker system in accordance with claim 1, wherein said means for disposable bags are on rolling system that dispenses the bags thru the disposable bag dispenser comprises a disposable bag dispensing unit.
